(19) United States
(12) Patent Application Publication
(10) Pub. No.: US 2014/0351095 A1
(43) Pub. Date: Nov. 27, 2014

(54) SYSTEM AND METHOD FOR PROCESSING DELAYED SALES ORDERS

(71) Applicant: Daniel Measurement and Control, Inc., Houston, TX (US)

(72) Inventors: Shankar Krishnamurthy, Houston, TX (US); Jon Milliken, Houston, TX (US); Lonna Dickenson, Houston, TX (US); Victor Salinas, Houston, TX (US); Auralicia Oropeza, Houston, TX (US); Hemant Arun Modak, Pune (IN); Bibek Mohanty, Pune (IN); Mickey Singh, Pune (IN)

(21) Appl. No.: 14/282,479

(22) Filed: May 20, 2014

Related U.S. Application Data
(60) Provisional application No. 61/826,064, filed on May 22, 2013.

(51) Int. Cl. G06Q 30/06

(52) U.S. Cl. CPC G06Q 30/0635
USPC 705/26.81

(57) ABSTRACT

A system and method for processing delayed sales order. In one embodiment a system for sales order processing includes one or more processors and instructions executable by the one or more processors. The instructions, when executed by the one or more processors, cause the one or more processors to 1) select from a plurality of stored sales orders, a first subset of the sales orders having a previously scheduled delivery date delayed by more than a predetermined time period; 2) associate with each sales order of the first subset a reason for the delivery date delay; 3) select from the first subset of the sales orders, a second subset of the sales orders associated with a given representative; and 4) display the second subset of the sales orders for viewing by the given representative.

### CROSS REFERENCE TO RELATED APPLICATION

The present application claims priority to U.S. Provisional Patent Application No. 61/826,064, filed on May 22, 2013 (Attorney Docket No. 1787-29100, M&C 201302); which is hereby incorporated herein by reference in its entirety.

### BACKGROUND

In businesses that produce and/or sell complex and/or custom equipment, the manufacturing/production of ordered equipment may be incomplete at the time of order acceptance. Consequently, ordered equipment may be unavailable for delivery at the time that the order is accepted. In such situations, the buyer and manufacturer may agree to a delivery date for the equipment in accordance the manufacturer's predicted production schedule and the buyer's anticipated need for the equipment. Inaccuracies in the manufacturer's scheduling or unanticipated disruptions in manufacturing processes, such as machinery malfunctions, delays in material deliveries, etc. may result in unforeseen equipment production delays. In some situations, excessive production delays may make delivery of the equipment by an agreed upon delivery date impossible.

### SUMMARY

A system and method for processing delayed sales orders and alerting a buyer with regard to a change in delivery date of equipment associated with a delayed sales order are disclosed herein. In some embodiments, a method for sales order processing includes: 1) selecting, by a processor, from a plurality of stored sales orders, a first subset of the sales orders having a previously scheduled delivery date delayed by more than a predetermined time period; 2) associating, by a processor, with each sales order of the first subset a reason for the delivery date delay; 3) selecting, by a processor, from the first subset of the sales orders, a second subset of the sales orders associated with a given representative; and 4) displaying, by a processor, the second subset of the sales orders for viewing by the given representative.

In some embodiments, a computer-readable storage device is encoded with instructions that when executed cause a processor to: 1) select from a plurality of stored sales orders, a first subset of the sales orders having a previously scheduled delivery date delayed by more than a predetermined time period; 2) associate with each sales order of the first subset a reason for the delivery date delay; 3) select from the first subset of the sales orders, a second subset of the sales orders associated with a given representative; and 4) display the second subset of the sales orders for viewing by the given representative.

In further embodiments, a system for sales order processing includes one or more processors and sales order alert logic. The sales order alert logic, when executed by the one or more processors, causes the one or more processors to 1) select from a plurality of stored sales orders, a first subset of the sales orders having a previously scheduled delivery date delayed by more than a predetermined time period; 2) associate with each sales order of the first subset a reason for the delivery date delay; 3) select from the first subset of the sales orders, a second subset of the sales orders associated with a given representative; and 4) display the second subset of the sales orders for viewing by the given representative.

### BRIEF DESCRIPTION OF THE DRAWINGS

For a detailed description of exemplary embodiments of the invention, reference will now be made to the accompanying drawings in which:

FIG. 1 shows a block diagram of a system for identifying and communicating changes associated with a sales order in accordance with principles disclosed herein;

FIG. 2 shows block diagram of a liaison device for communicating changes associated with a sales order in accordance with principles disclosed herein;

FIG. 3 shows a flow diagram for a method for identifying and communicating changes associated with a sales order in accordance with principles disclosed herein;

FIG. 4 shows a display of a liaison authentication dialog generated by a liaison device in accordance with principles disclosed herein;

FIG. 5 shows a display of a dialog listing sales orders with delivery delays in accordance with principles disclosed herein;

FIG. 6 shows a display of a dialog showing a selected sales order with delivery delays in accordance with principles disclosed herein;

FIG. 7 shows a display of a dialog showing details of a selected sales order with delivery delays in accordance with principles disclosed herein;

FIG. 8 shows a display of a dialog showing reasons for delay in a selected sales order in accordance with principles disclosed herein; and

FIG. 9 shows a display of a dialog for entry of purchaser comments responsive to delivery delay notification in accordance with principles disclosed herein.

### NOTATION AND NOMENCLATURE

In the following discussion and in the claims, the terms “including” and “comprising” are used in an open-ended fashion, and thus should be interpreted to mean “including, but not limited to . . . ”. Any use of any form of the terms “connect”, “engage”, “couple”, “attach”, or any other term describing an interaction between elements is not meant to limit the interaction to direct interaction between the elements and may also include indirect interaction between the elements described. The term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of additional factors.

### DETAILED DESCRIPTION

In the drawings and description that follow, like parts are typically marked throughout the specification and drawings with the same reference numerals. The drawing figures are not necessarily to scale. Certain features of the disclosed embodiments may be shown exaggerated in scale or in somewhat schematic form, and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings and components of the embodiments discussed below may be employed separately or in any suitable combination to produce desired results.

Timely communication to a purchaser of changes in order scheduling is important for a variety of reasons. In some cases, installation of equipment may be scheduled based on an agreed upon delivery date. Installation costs may be substantial, and if not notified of a change in delivery date, the purchaser may incur additional expense associated with the rescheduled installation. Timely communication of equipment delivery delay may allow the purchaser to avoid or minimize such additional expense. Furthermore, failure to deliver equipment by an agreed upon delivery date may result in a loss of goodwill with regard to the equipment manufacturer.

Communication of equipment production and associated delivery delays is dependent on communication of changes in production scheduling to a customer liaison who is responsible for communication with the purchaser. A salesperson or other entity representative assigned to manage the purchaser's account may serve as such a customer liaison. Embodiments of the present disclosure are intended to provide enhanced customer loyalty and increased manufacturer goodwill via application of a system for timely recording and communication of changes in scheduled delivery dates, and causes of the changes. The system automatically sorts delayed sales orders according to customer liaison and communicates recorded changes in delivery dates along with the causes thereof to the customer liaison responsible for notifying the purchaser of the delay. The system further provides for communication and recording of customer feedback associated with notification of delivery delays.

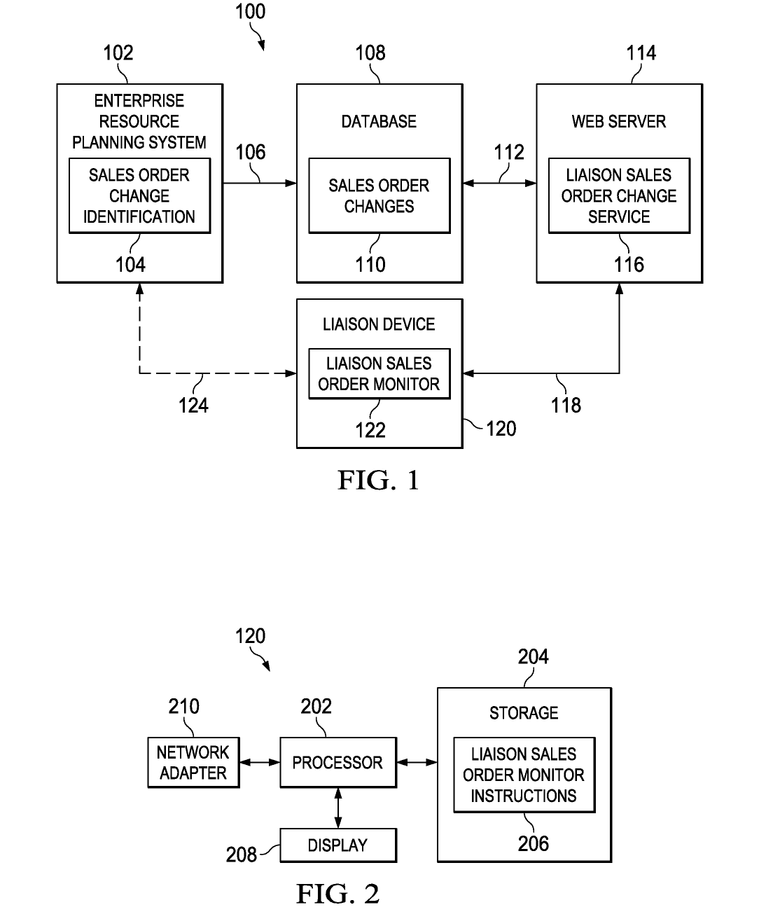

FIG. 1 shows a block diagram of a system 100 for identifying and communicating changes associated with a delayed sales order in accordance with principles disclosed herein. The system 100 includes an enterprise resource planning (ERP) system 102, a database 108, a sales order change web server 114, and a liaison device 120. The ERP system 102 manages planning and scheduling of manufacturing of products, such as equipment, sold by the entity. When production planning personnel determine that the production schedule of a piece of equipment has changed, the planning personnel enter information into the ERP system 100 that identifies the equipment for which the production schedule is changed and enter information indicating a cause or causes of the production schedule change. For example, the production schedule change may be caused by a machinery breakdown, a defect in materials incorporated in the equipment, delay in receipt of materials, etc.

The ERP system 102 is a computer-based system that includes a computer that executes instructions of a software program to provide functionality. For example, the ERP system 102 may include software programming the causes a computer to provide for entry and storage of equipment scheduling information, such as delivery date changes, and equipment schedule change cause information. For example, the ERP system 102 may include JD EDWARDS ERP software.

The ERP system 102 includes sales order change identification logic 104. The sales order change identification logic 104 examines the equipment production records stored by or accessible to the ERP system 102 and identifies equipment and associated sales orders having delivery dates that have changed. For example, the sales orders and/or associated equipment may be flagged as having delayed delivery when a production planner enters scheduling change information for the equipment, and the sales order change identification logic 104 may identify records so flagged. In other embodiments, the sales order change identification logic 104 may compare a later entered delivery date to a previously entered delivery date to identify delayed sales orders. Some embodiments of the sales order change identification logic 104 may identify only those sales orders having a delivery date changed by more than a predetermined amount (e.g., delayed by seven days or more).

The ERP system 102 provides information 106 identifying the sales orders and/or equipment associated with the sales orders that have delayed delivery dates to the database 108. In some embodiments, ERP system 102 may arrange the information 106 as a spreadsheet formatted in accordance with EXCEL by MICROSOFT Corporation. The database 108 stores the information 106 as sales order changes 110. The database 108 may be a relational database, an object oriented database, etc. The database 108 includes a computer and database software that is executed by the computer to process and store the sales order changes 110. For example, the database 108 may include relational database software from ORACLE Corporation executing on a computer. The database 108 may be coupled to the ERP system 102 via a network, such as a local area network (LAN), a wide area network (WAN), the internet, etc. In some embodiments, of the system 100, the database 108 and the ERP system 102 may share a computing resource, such as a processor.

The sales order change web server 114 is coupled to the database 108. The web server 114 can access the database 108 to retrieve sales order changes 110. The web server 114 includes a liaison sales order change service module 116. The change service module 116, when executed by a computer, causes the web server 114 to retrieve records of sales order changes 110 from the database 108. Some embodiments of the change service module 116 may retrieve change records associated with a particular customer liaison from the database 108. Other embodiments of the change service module 116 may retrieve all change records stored in the sales order changes 110 from the database 108 and sort the change records according to customer liaison. The web server 114 may be coupled to the database 108 via a network, such as a LAN, a WAN, the internet, etc. In some embodiments, of the system 100, the database 108 and the web server 114 may share a computing resource, such as a processor.

The liaison device 120 is a mobile computing device that may operate as a client of the web server 114. The liaison device 120 provides an interface that allows the customer liaison operating the liaison device 120 to access and/or view information identifying sales orders and equipment associated with the sales orders that have changed delivery dates. The liaison device 120 includes a liaison sales order monitor 122 that communicates with the web server 114 and displays changed sales order information retrieved from the web server 114. The liaison device 120 also allows for feedback 124 of customer commentary associated with a changed delivery date and acknowledgement that a sales order change has been communicated to the purchaser. While feedback 124 is illustrated in FIG. 1 as flowing directly between the liaison device 120 and the ERP system 102, in practice the liaison device 120 may provide the feedback via the web server 114, or via an email or other communication path that results in the feedback 124 being stored in a record associated with the changed sales order in the ERP system 102.

FIG. 2 shows a block diagram of the liaison device 120. The liaison device 120 is a mobile computing device that allows a customer liaison to interact with the web server 114, the database 108, and ERP system 102. The liaison device 120 includes a processor 202, storage 204, a network adapter 210, and a display 208. The liaison device 120 may also include various additional user interface components (e.g., a touchscreen), audio components, etc. The processor 202 may be a general-purpose microprocessor, digital signal processor, microcontroller, or other device capable of executing instructions retrieved from a computer-readable storage medium. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

As understood by those of ordinary skill in the art, processors execute software instructions. Software instructions alone are incapable of performing a function. Therefore, in the present disclosure, any reference to a function performed by software instructions, or to software instructions performing a function is simply a shorthand means for stating that the function is performed by a processor executing the instructions.

The display 208 is coupled to the processor 202. The processor 202 provides data to the display 208 for presentation. The display 208 may include a liquid crystal display device, an organic light emitting diode display device, or any other display technology suitable for use in the mobile computing device 120.

The network adapter 210 is coupled to the processor 202. The network adapter 210 allows the liaison device 120 to wirelessly communicate with the web server 114. For example, the network adapter 210 may include circuitry that allows the liaison device 120 to wirelessly communicate with the web server 114 via a WLAN (e.g., a WLAN according to an IEEE 802.11 standard), a WAN, such as a cellular communication network (long term evolution, global system for mobile communication, etc.), or other wireless network.

The storage 204 is a non-transitory computer-readable storage medium suitable for storing instructions executable by the processor 202, for storing sales order change information retrieved from the web server 114, and other instructions and/or data. The storage 204 may include volatile storage such as random access memory, non-volatile storage (e.g., a hard drive, an optical storage device (e.g., CD or DVD), FLASH storage, read-only-memory), or combinations thereof.

The storage 204 includes a liaison sales order monitor module 206 that includes instructions executed by the processor 202 to retrieve and display sales order changes. The liaison sales order monitor module 206 allows for entry of identity information of a customer liaison using the device 120, presents the identity information to the web server 114 for authentication, displays changed sales order information associated with the customer liaison on the display 208, and provide for entry and transmission of customer commentary received with respect the change in delivery date.

In some embodiments, the liaison device 120 may be a smartphone, a tablet computer, or other suitable mobile computing device. The ERP system 102, database 108, and web server 114 may be architecturally similar to the liaison device 120 in that each of the ERP system 102, database 108, and web server 114 may include a processor and storage from which the processor retrieves instructions to be executed for performing the functions described herein. In some embodiments, the ERP system 102, database 108, and web server 114 are coupled via one or more networks, such as a local area network, a wide area network, the Internet, etc. In some embodiments, two or more of the ERP system 102, database 108, and web server 114 may share a hardware platform or computer.

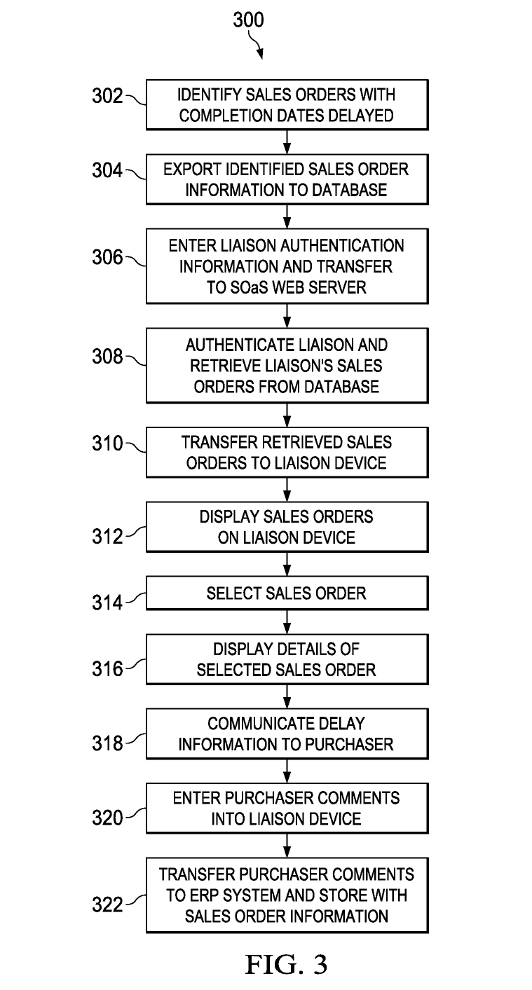

FIG. 3 shows a flow diagram for a method 300 for identifying and communicating changes associated with a sales order in accordance with principles disclosed herein. Though depicted sequentially as a matter of convenience, at least some of the actions shown can be performed in a different order and/or performed in parallel. Additionally, some embodiments may perform only some of the actions shown. In some embodiments, at least some of the operations of FIG. 3, as well as other operations described herein, can be implemented via execution of instructions stored in a computer readable medium by one or more processors.

In block 302, manufacturing planning personnel have identified equipment for which delivery will be delayed relative to a previously planned delivery date. The planning personnel enter the revised delivery date and a reason for the delay into the ERP system 102. In some embodiments, the ERP system 102 may provide a user interface that allows planning personnel to select from a plurality of predefined reasons (e.g., 30 or more reasons) for the delay, and to enter other information relevant to the delay. The ERP system 302 identifies sales orders having equipment delivery dates that have changed by a predetermined amount of time. For example, the ERP system 102 may identify sales orders having equipment delivery dates that have changed by at least a week. The identification of such sales orders may include comparing a latest entered delivery date to a previously entered delivery date, detection of a flag indicating a delivery date change, etc.

In block 304, the ERP system 102 exports records or other forms of information indicative of the identified sales orders, the revised delivery dates, the reasons for delivery date change, customer liaison responsible for the sales order, etc. to the database 108 for storage. In some embodiments, the ERP system 102 formats the information as an EXCEL spreadsheet. Other embodiments may apply different formatting.

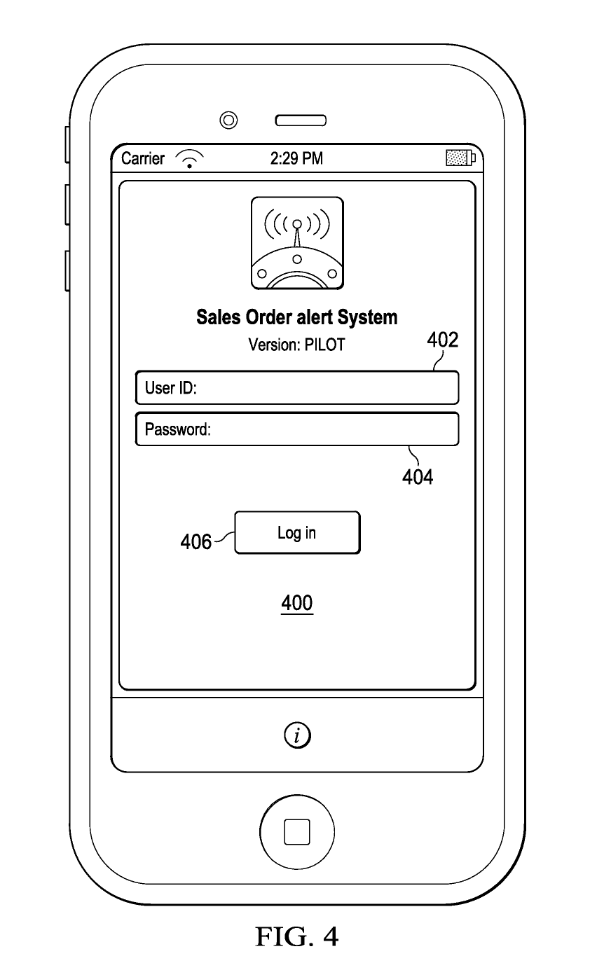

In block 306, a customer liaison, enters liaison authentication information into the liaison device 120 to initiate access to changed sales orders associated with the customer liaison. FIG. 4 shows a display of an illustrative liaison authentication dialog 400 generated by the liaison device 120. The authentication dialog 400 includes an USER ID field 402 and a PASSWORD field 404 into which the customer liaison enters authentication information. When the customer liaison presses the LOG IN button 406, the liaison device 120 transmits the authentication information to the web server 114.

In block 308, the web server 114 authenticates the customer liaison based on the authentication information transferred from the liaison device 120. If authentication is successful, the web server 114 accesses the database 108 and retrieves from the database 108 sales order change information associated with the customer liaison.

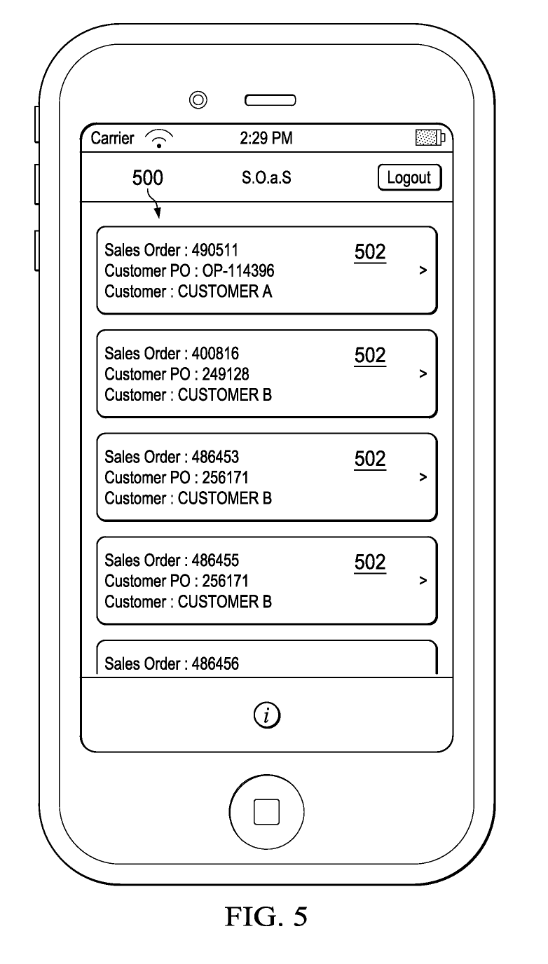

In block 310, the web server 114 transfers the retrieves sales order change information to the liaison device 120. The liaison device 120 receives the sales order change information and displays the received information in block 312. FIG. 5 shows a display of an illustrative dialog 500 generated by a liaison device 120. The dialog 500 includes a series of sales order fields 502 providing information concerning sales orders with delivery delays. The dialog 500 may include only sales orders for which the customer liaison is responsible. In the illustrative dialog 500, each sales order field 502 lists a sales order having a changed delivery date and includes a sales order number, a customer purchase order number, and the name of the customer/purchaser.

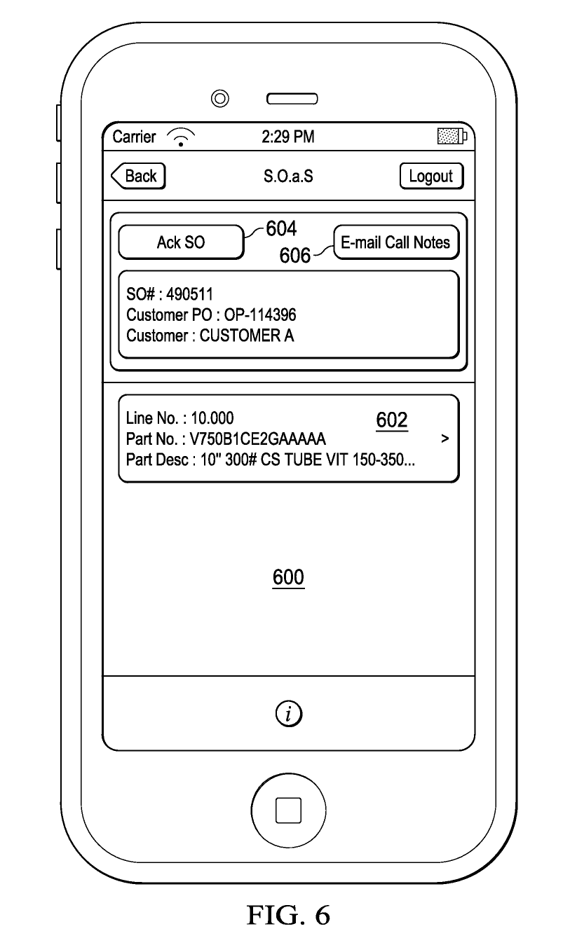

In block 314, the customer liaison selects one of the sales order fields 502. For example, the customer liaison may tap one of the sales orders fields 502. Selection of a sales order field 502 may cause the liaison device 120 to display, in block 316, additional details of the sales order listed in the selected field 502. FIG. 6 shows a display of an illustrative dialog 600 showing information regarding a sales order of a selected sales order field 502. The dialog 600 includes an equipment information field 602 that provides information regarding equipment listed on or associated with the sales order that has been delayed. As shown in FIG. 6, the equipment information field 602 may identify equipment by sales order line number, equipment part number, and/or equipment part description.

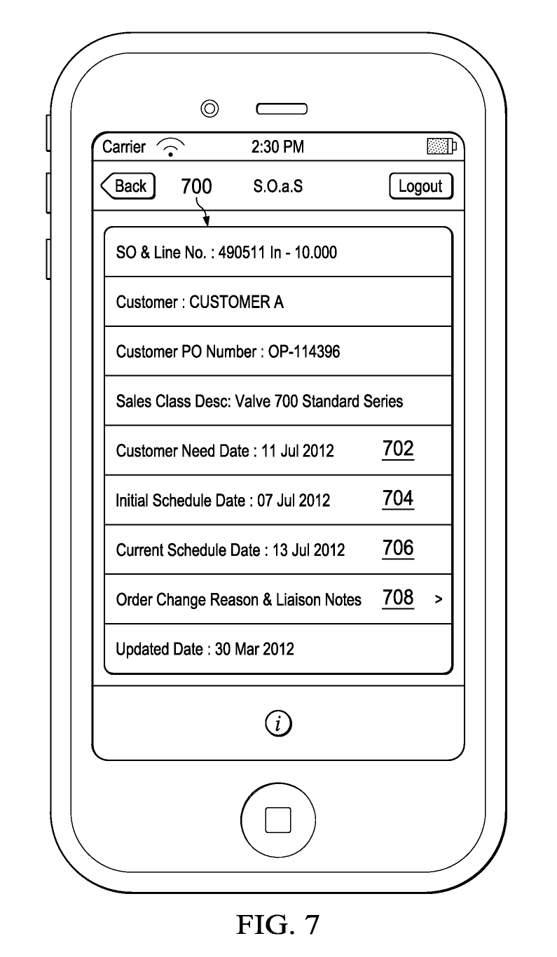

While viewing the dialog 600, the customer liaison may select (e.g., tap) the equipment field 602 to cause the liaison device 120 to display additional information. FIG. 7 shows a display of an illustrative dialog 700 showing additional details of the equipment of selected equipment field 602. More specifically, dialog 700 displays a recorded date of customer need 702 for the equipment, an initial scheduled delivery date 704 for the equipment, a current (revised/delayed) delivery date 706 for the equipment, and a change reason selection field 708 for selection of an additional change reason display. Selection (tapping) of the change reason display field 708 causes the liaison device 120 to display a change reason details dialog.

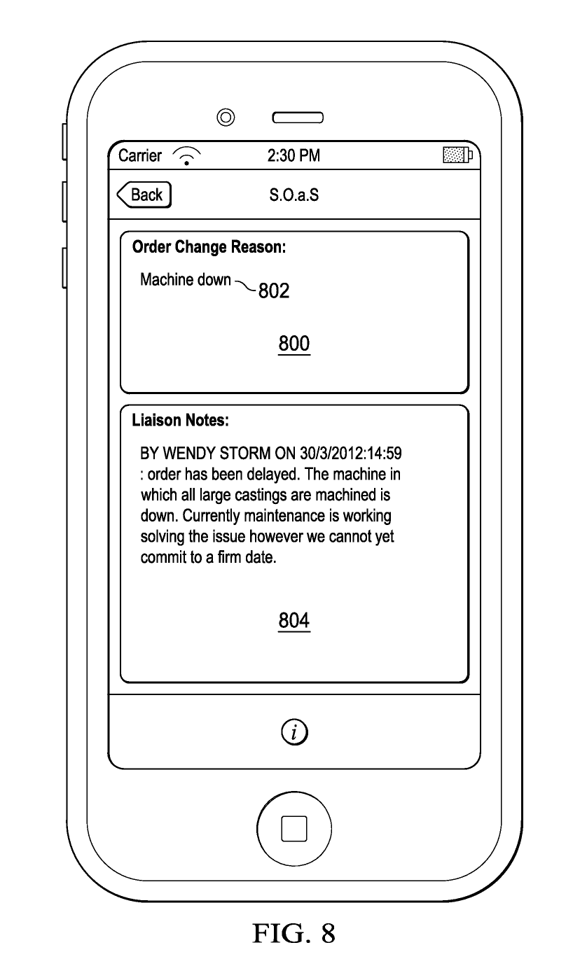

FIG. 8 shows a display of an illustrative change reason details dialog 800. The change reasons details dialog 800 includes a change reason field 802 and a liaison notes field 804. The change reason field 802 shows the reason that the delivery data of the equipment has changed. The displayed reason may correspond to the reason entered in the ERP system 102 by planning personnel. The liaison notes field 804 provides additional information regarding the change reason (e.g., underlying cause of the change, corrective measures being taken, expected resolution date, etc.).

Having examined the details of sales order change, the customer liaison communicates the information provided by the liaison device 102 to the purchaser of the delayed equipment in block 318. In turn, the purchaser may provide comments to the customer liaison regarding the changed delivery date, impact of the change on the purchaser, a revised need date, etc. In block 320, the customer liaison enters the purchaser's comments into the liaison device 120.

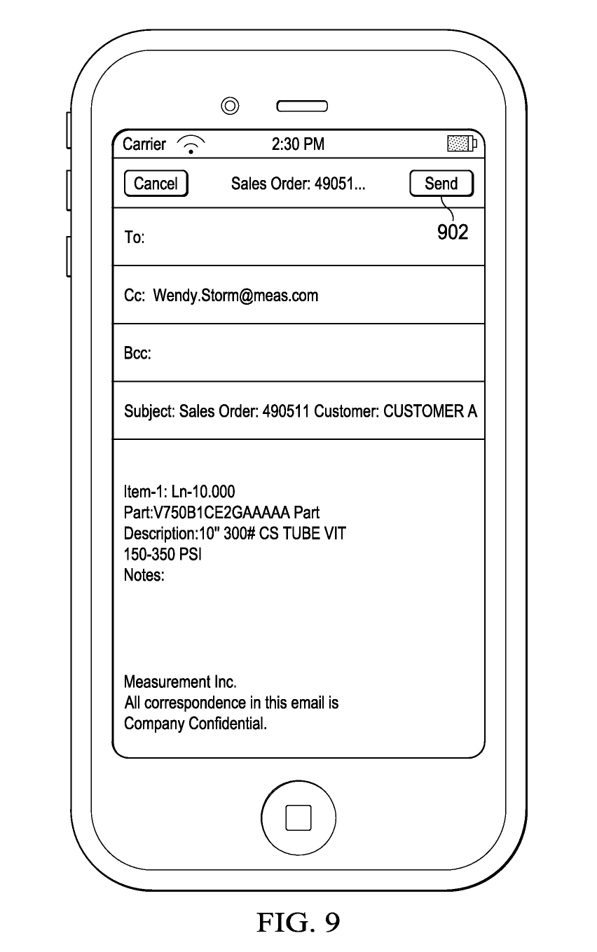

The dialog 600 includes an EMAIL CALL NOTES button 606. When the customer liaison selects (e.g., taps) the EMAIL CALL NOTES button 606, the liaison device 120 provides for entry of customer comments related to the delayed equipment 602 as shown in FIG. 9. The customer liaison enters the customer comments and, in block 322, transmits the purchaser's comments to the ERP system 102 for storage along with records pertaining to the sales order of dialog 600. In some embodiments, selecting (e.g., tapping) the SEND button 902 causes the liaison device 120 to transmit the purchaser's comments.

The dialog 600 also includes an ACK button. When the customer liaison selects (e.g., taps) the ACK button 604, the liaison device 120 transmits an acknowledgement to the web server 114 indicating that the customer identified in dialog 600 has been notified of the delayed delivery date. Based on reception of the acknowledgement, the web server 114 may cause the database 108 and/or the ERP system 102 to flag the delayed sales order corresponding to the dialog 600 as having been reported to the purchaser. Accordingly, the web server 114 may omit the sales order of dialog 600 from a set of sales orders transferred to the liaison device 120 unless the sales order is further delayed after receipt of the acknowledgement.

The above discussion is meant to be illustrative of certain principles and various exemplary embodiments of the present invention. Numerous variations and modifications will become apparent to those of ordinary skill in the art once the above disclosure is fully appreciated. It is intended that the following claims be interpreted to embrace all such variations and modifications.

What is claimed is:

1. A method for sales order processing, comprising:
selecting, by a processor, from a plurality of stored sales orders, a first subset of the sales orders having a previously scheduled delivery date delayed by more than a predetermined time period;
associating, by a processor, with each sales order of the first subset a reason for the delivery date delay;
selecting, by a processor, from the first subset of the sales orders, a second subset of the sales orders associated with a given representative;
displaying, by a processor, the second subset of the sales orders for viewing by the given representative.

2. The method of claim 1, further comprising:
authenticating the identity of the given representative;
wherein the displaying of the second subset is based on success of the authenticating.

3. The method of claim 2, wherein the selecting of the second subset is based on success of the authenticating.

4. The method of claim 1, further comprising providing in association with each sales order of the first set:
the previously scheduled delivery date; and
a revised delivery date that accounts for the delivery date delay.

5. The method of claim 1, further comprising displaying, responsive to selection a sales order of the second subset, information comprising:
a description of the goods delayed;
the reason for the delivery date delay;
the previously scheduled delivery date; and
a revised delivery date that accounts for the delivery date delay.

6. The method of claim 1, further comprising:
providing, in conjunction with the displaying of each sales order of the second subset, a field for entry of customer response to the delivery date delay of the sales order; and
storing information indicative of the customer response in association with the sales order.

7. The method of claim 1, further comprising:
providing the first subset of the sales orders for access via the internet via a web server; and
selecting the second subset by one of the web server and a handheld computing device that accesses the web server via the internet.

8. A computer-readable storage device encoded with instructions that when executed cause a processor to:
select from a plurality of stored sales orders, a first subset of the sales orders having a previously scheduled delivery date delayed by more than a predetermined time period;
associate with each sales order of the first subset a reason for the delivery date delay;
select from the first subset of the sales orders, a second subset of the sales orders associated with a given representative;
display the second subset of the sales orders for viewing by the given representative.

9. The storage device of claim 8, wherein the instructions cause the processor to:
authenticate the identity of the given representative; and
display the second subset based on success of the authentication.

10. The storage device of claim 9, wherein the instructions cause the processor to select the second subset based on success of the authentication.

11. The storage device of claim 8, wherein the instructions cause the processor to provide in association with each sales order of the first set:
the previously scheduled delivery date; and
a revised delivery date that accounts for the delivery date delay.

12. The storage device of claim 8, wherein the instructions cause the processor to display information associated with a sales order of the second subset, responsive to selection of the sales order, the information comprising:
a description of the goods delayed;
the reason for the delivery date delay;
the previously scheduled delivery date; and
a revised delivery date that accounts for the delivery date delay.

13. The storage device of claim 8, wherein the instructions cause the processor to:
provide, in conjunction with the displaying of each sales order of the second subset, a field for entry of customer response to the delivery date delay of the sales order; and
store information indicative of the customer response in association with the sales order.

14. The storage device of claim 8, wherein the instructions cause the processor to:
provide the first subset of the sales orders for access via the internet via a web server; and
select the second subset by one of the web server and a handheld computing device that accesses the web server via the internet.

15. A system for sales order processing, comprising:
one or more processors; and
instructions that, when executed by the one or more processors, cause the one or more processors to:
select from a plurality of stored sales orders, a first subset of the sales orders having a previously scheduled delivery date delayed by more than a predetermined time period;
associate with each sales order of the first subset a reason for the delivery date delay;
select from the first subset of the sales orders, a second subset of the sales orders associated with a given representative;
display the second subset of the sales orders for viewing by the given representative.

16. The system of claim 15, wherein the instructions cause the one or more processors to:
authenticate the identity of the given representative; and
display of the second subset based on success of the authentication.

17. The system of claim 16, wherein the instructions cause the one or more processors to select the second subset based on success of the authenticating.

18. The system of claim 15, wherein the instructions cause the one or more processors to provide in association with each sales order of the first set:
the previously scheduled delivery date; and
a revised delivery date that accounts for the delivery date delay.

19. The system of claim 15, wherein the instructions cause the one or more processors to display information associated with a sales order of the second subset, responsive to selection of the sales order, the information comprising:
a description of the goods delayed;
the reason for the delivery date delay;
the previously scheduled delivery date; and
a revised delivery date that accounts for the delivery date delay.

20. The system of claim 15, wherein the instructions cause the one or more processors to:
provide, in conjunction with the displaying of each sales order of the second subset, a field for entry of customer response to the delivery date delay of the sales order; and
store information indicative of the customer response in association with the sales order.

21. The system of claim 15, further comprising a web server configured to provide the first subset of the sales orders for access via the internet; wherein one of the web server and a handheld computing device that accesses the web server via the internet is configured to select the second subset.
